(19) United States
(12) Patent Application Publication
(10) Pub. No.: US 2006/0013914 A1
(43) Pub. Date: Jan. 19, 2006

(54) Rotary powder compression molding machine

(75) Inventors: Keiji Shimada, Kyoto (JP); Yoshitsugu Oneda, Shiga (JP)

Correspondence Address: BANNER & WITCOFF, 1001 G STREET N W, SUITE 1100, WASHINGTON, DC, 20001, US

(73) Assignee: Kikusui Seisakusho Ltd., Kyoto (JP)

(21) Appl. No.: 10/498,120

(22) PCT Filed: Aug. 6, 2002
(86) PCT No.: PCT/JP02/08040

§ 371 Date: Jul. 21, 2005

(30) Foreign Application Priority Data
Dec. 19, 2001 (JP) 2001-386632

(51) Int. Cl. B29C 35/00

(52) U.S. Cl. 425/408

(57) ABSTRACT

In a rotary compressive molding machine for powder material wherein powder material filled in a die hole of a die mounted on a rotary table is compressed and molded between a lower end face of the upper punch and an upper end face of the lower punch, a powder lubricant spraying means that sprays powder lubricant comprises a spray nozzle that has a concave face facing to the lower end face of the upper punch or the upper end face of the lower punch at a position where the powder lubricant is sprayed and that sprays the powder lubricant generally toward a direction of the lower end face of the upper punch or the upper end face of the lower punch guided by the concave face, an air current supply mechanism that prevents the powder lubricant sprayed from the spray nozzle from scattering upward by spraying air near the lower end face of the upper punch, and an electrostatic charge device that electrizes the powder lubricant when the powder lubricant is sprayed from the spray nozzle and that electrizes at least the upper punch, the lower punch and the die with an antipolarity against the electrized powder lubricant.

### FIELD OF THE ART

This invention relates to a rotary compressive molding machine for powder material that compresses powder material in order to mold a tablet or the like.

### BACKGROUND ART

Conventionally, in case medical tablets are manufactured by the use of this kind of rotary compressive molding machine if raw powder material of a medical tablet is made of a medicine formulation ingredient alone, a sticking phenomenon such that the raw powder material or the medical tablet sticks into a punch or a die might occur. In order to prevent this kind of problem, a method for tableting the powder material wherein powder lubricant such as magnesium stearate or the like is mixed into the raw powder material has been generally used.

Senile medical field is recently considered to be essential. This increases a demand for tablets which are easy to melt or collapse in a mouth so that elder persons can swallow it without difficulty or for tablets which melt immediately after swallowed so as to produce the efficacy of the medicine. However, in case the medical tablets are manufactured by the above-mentioned conventional method the powder lubricant mixed into the raw powder material hinders collapsing or melting in a mouth, which makes it difficult to meet the above-mentioned demand. In addition, due to a mixture of the powder lubricant, the tablets become fragile.

In view of the situation and with an object to prevent a sticking phenomenon considered, there is no need of mixing the powder lubricant with a medicine formulation ingredient. Then it has been examined that the lubricant is sprayed so as to adhere to a part alone where a sticking phenomenon occurs such as a surface of the punches and the tablet can be made of the powder material made of a medicine formulation ingredient alone. In view of the above, it has been conceived that powder lubricant is sprayed to the upper and the lower punches and the die hole prior to tableting or that the powder lubricant alone is compressed prior to tableting so as to cover the upper punch, the lower punch and the die hole with the powder lubricant.

For the former one, however, there might be a problem, so-called contamination, that the powder lubricant is scattered when sprayed or a problem of contamination such that powder lubricant is mixed with a medicine formulation ingredient or a medicine formulation ingredient is mixed into powder lubricant when the lubricant is sprayed and the powder lubricant might not adhere evenly to the punches or the like. In order to prevent the powder lubricant from scattering it has been conceived that the punches are surrounded at a position where the powder lubricant is sprayed. However, this arrangement requires an opening through which the powder lubricant passes for the upper punch, thereby to be unable to suppress scattering the powder lubricant effectively.

In addition, for the later one, since a compressive mechanism is required to compress the powder material, the machine is jumboized and time for tableting drops to generally half of ordinary time. Various methods have been conceived in addition to the above, however, either of them has a similar problem during an actual tableting process.

### DISCLOSURE OF THE INVENTION

The present claimed invention intends to solve all of the above problems.

The present claimed invention devises a following means to attain the above object. More specifically, the rotary compressive molding machine for powder material in accordance with this invention is so arranged that a rotary table is rotatably arranged in a frame through an upright shaft, a die having a die hole is arranged on the rotary table, an upper punch and a lower punch are kept above and below the die in a vertically slidable condition and powder material filled in the die hole is compressed and molded between a lower end face of the upper punch and an upper end face of the lower punch by pushing the upper punch and the lower punch so as to approach each other with their tip inserted into the die hole and comprises a powder lubricant spraying means that sprays powder lubricant to the upper end face of the lower punch, the lower end face of the upper punch and the die hole prior to filling the powder material, and is characterized by that the powder lubricant spraying means comprises a spray nozzle that has a concave face facing to the lower end face of the upper punch or the upper end face of the lower punch at a position where the powder lubricant is sprayed and that sprays the powder lubricant generally toward a direction of the lower end face of the upper punch or the upper end face of the lower punch guided by the concave face, an air current supply mechanism that prevents the powder lubricant sprayed from the spray nozzle from scattering upward by spraying air near the lower end face of the upper punch, and an electrostatic charge device that electrizes the powder lubricant when the powder lubricant is sprayed from the spray nozzle and that electrizes at least the upper punch, the lower punch and the die to an antipolarity against the electrized powder lubricant.

The powder lubricant in accordance with this embodiment is stearic acid, stearate (metallic salt such as Al, K, Na, Ca, Mg) or fine particles having water repellency such as sodium lauryl sulfate and is to restrain powder material from attaching to inside a die or a distal end of upper and lower punches in case of compressing powder material to mold a tablet or the like by the compressive molding machine for powder material.

In accordance with the arrangement, since the powder lubricant is sprayed generally toward a direction of the end face of the punch by making use of the concave face of the spray nozzle, it is possible for the powder lubricant to reach the lower end face of the upper punch, the upper end face of the lower punch and the die hole effectively. In addition, since the powder lubricant sprayed from the spray nozzle is electrized by the electrostatic charge device and at least the upper punch, the lower punch and the die are electrized with an antipolarity against the sprayed powder lubricant, the powder lubricant electrostatically attaches to the end face of the upper and the lower punches and the inner face of the die hole due to electrostatic attraction. This makes it possible to improve efficiency of attaching the powder lubricant surely.

In addition, since an air current is formed near the lower end face of the upper punch by the air current supply mechanism, superfluous powder lubricant that has not been attached to the lower end face of the upper punch is prevented from going upward, thereby to prevent the powder lubricant from scattering. As a result, it is possible to prevent the superfluous powder lubricant from attaching to a portion other than the lower end face of the upper punch and to attach the powder lubricant effectively to the lower end face of the upper punch alone.

Further, since it is possible to prevent the superfluous powder lubricant from attaching to the portion other than the lower end face of the upper punch if the powder lubricant is prevented from scattering as mentioned above, a problem can be prevented such that the upper punch is hindered from a smooth movement due to a frictional force because of the powder lubricant attaching to the upper punch when the upper punch makes a movement. In addition, it is possible to avoid the superfluous powder lubricant from dropping and mixing into powder material to be compressed after the superfluous powder lubricant becomes big.

As the electrostatic charge device it is preferable to comprise an electrode that forms an electric field where the powder lubricant sprayed from the spray nozzle passes. If the electrode is provided, it is possible to electrize the powder lubricant effectively. In this case it is preferable that the electric field is formed in a space formed by the concave face of the spray nozzle. If the electric field is formed, it is possible to electrize almost every amount of the powder lubricant guided along the concave face of the spray nozzle just after the powder lubricant is sprayed from the spray nozzle.

It is preferable that the powder lubricant spraying means further comprises a powder sucking mechanism that sucks the powder lubricant that is prevented from moving upward by the air current supply mechanism. If the superfluous powder lubricant is sucked as mentioned, the superfluous powder lubricant can be retrieved effectively.

In addition, in order to minimize an amount of the superfluous scattering powder lubricant it is preferable that the powder lubricant spray means further comprises a box body that surrounds a position where the powder lubricant is supplied, the concave face of the spray nozzle is arranged in the box body and superfluous powder lubricant scattering out of the box body is sucked by the powder sucking mechanism after passing inside the box body through an air current due to the air current supply mechanism.

In order to guide the powder lubricant to generally one direction uniformly it is preferable that the concave face of the spray nozzle is formed in a three-dimensional curved surface.

In order to supply the powder lubricant stably, it is preferable that a device for spraying powder lubricant that pressurizedly sends out the powder lubricant to the powder lubricant spray means is further provided and the powder lubricant spray means and the device for spraying powder lubricant are communicating by a supply pipe line that is free from an effect of electrostatic. If the powder lubricant spray means and the device for spraying powder lubricant are communicating by the supply pipe line, the powder lubricant flows without attaching to inside the supply pipe due to an electrostatic effect, thereby to spray the powder lubricant continuously.

It is preferable that the supply pipe line comprises an inner pipe made of insulating material inside of which the powder lubricant passes and an outer pipe made of electrically conductive material that covers the inner pipe and the outer pipe is connected to ground electrically.

In order to minimize an amount of the powder lubricant mixed into the powder material to be compressed it is preferable that an insulating layer is formed on the rotary table. In addition, in order to further decrease the amount of the powder lubricant mixed into the powder material it is preferable that an insulating layer is formed on the upper face of the die except for vicinity of the die hole.

Further, in order to retrieve the superfluous powder material effectively it is preferable to comprise a nozzle that supplies an air current for electricity removal on the upper face of the rotary table to remove electricity from the powder lubricant remaining on the upper face of the die and an intake that sucks the powder lubricant from which electricity is removed. If the powder lubricant that has not been used for compressing the powder material is retrieved as mentioned above, it is possible to measure an amount of the powder lubricant that has actually been used accurately and to improve a use efficiency of the powder lubricant.

### BRIEF DESCRIPTION OF THE DRAWINGS

FIG. 1 is a front cross-sectional view of a rotary compressive molding machine for powder material showing one embodiment of the invention.

FIG. 2 is a schematic plane view showing a rotary table of the embodiment.

FIG. 3 is a cross-sectional front view showing the rotary table of the embodiment in a developed condition.

FIG. 4 is a magnified plane view showing a spray portion of powder material of the embodiment.

FIG. 5 is a cross-sectional end view taken along the line I-I in FIG. 4.

FIG. 6 is a cross-sectional end view taken along the line II-II in FIG. 4.

FIG. 7 is a side view of a distal end of the upper nozzle (lower nozzle) of the embodiment.

FIG. 8 is a cross-sectional view taken along the line III-III in FIG. 7.

FIG. 9 is a block diagram showing a general arrangement of a powder lubricant supplying device in accordance with the embodiment.

FIG. 10 is a side view of a distal end of the upper nozzle (lower nozzle) showing a modified form of an electrode in accordance with the embodiment.

FIG. 11 is a cross-sectional view taken along the line IV-IV in FIG. 10.

FIG. 12 is a cross-sectional view showing a magnified principal part of the rotary table in accordance with another embodiment.

FIG. 13 is a plane view showing a bottom face of a principal part of a box body of the powder lubricant spray portion of the embodiment.

FIG. 14 is a cross-sectional view of the principal part of the box body of the powder lubricant spray portion of the embodiment.

FIG. 15 is a block diagram showing a general arrangement of a powder lubricant supplying device in accordance with the embodiment.

FIG. 16 is a cross-sectional view showing a magnified general arrangement of a retrieved amount detect portion of the embodiment.

### BEST MODES OF EMBODYING THE INVENTION

The invention will be described in detail with reference to an embodiment thereof shown in the accompanying drawings.

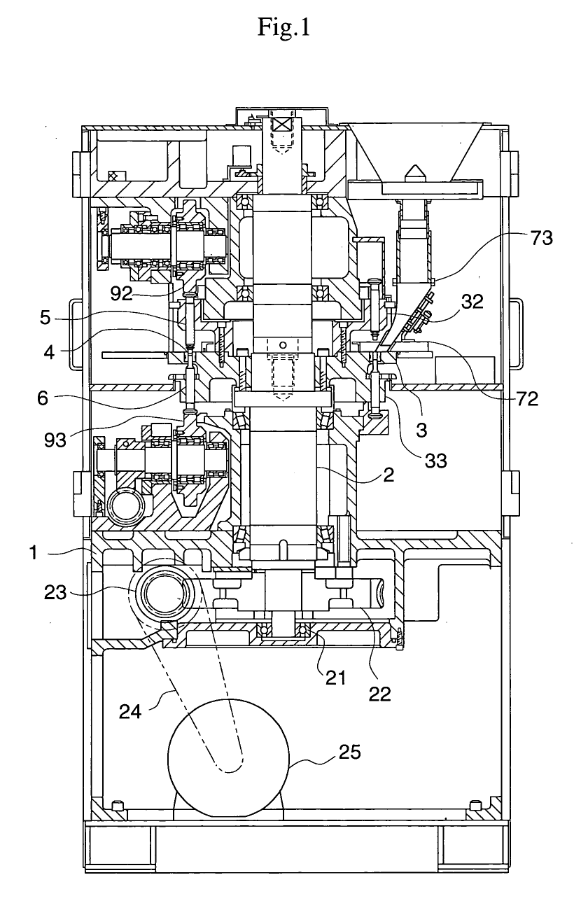

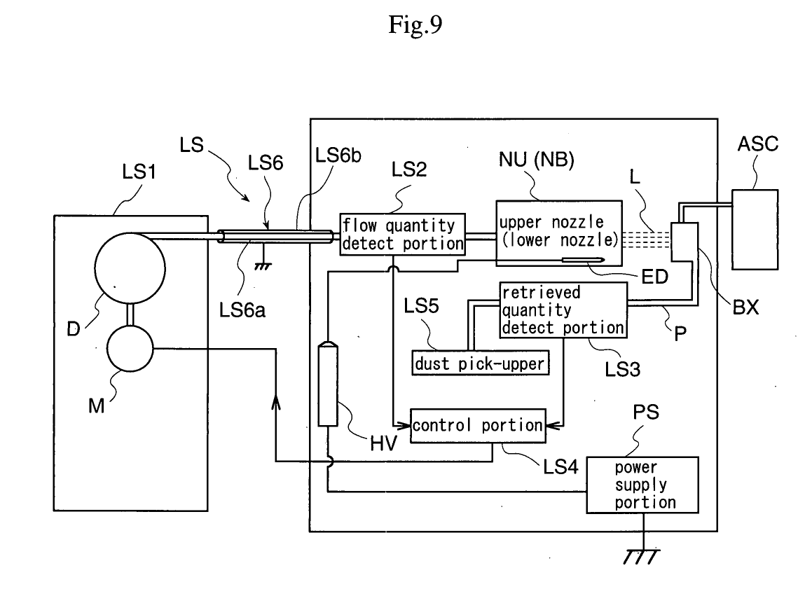

FIG. 1 shows a general arrangement of the rotary compressive molding machine for powder material of the invention. The rotary compressive molding machine for powder material has a device LS (FIG. 9) for spraying powder lubricant that sprays powder lubricant L, and a rotary table 3 is horizontally rotatably arranged in a frame 1 through an upright shaft 2, multiple dies 4 are arranged on the rotary table 3 at a predetermined pitch and upper punches 5 and lower punches 6 are kept in a vertically slidable condition above and below of each dies 4.

More specifically, the upright shaft 2 supported by a bearing 21 is arranged at a general center portion of the frame 1 and a worm wheel 22 is fixed near a bottom end of the upright shaft 2 so that rotational driving force of a motor 25 is transmitted to the worm wheel 22 through a worm 23 and a belt 24. The rotary table 3 that is divided into two functional parts is fixed near a head of the upright shaft 2.

The rotary table 3 comprises an upper punch retain portion 32 that is provided at an upper side portion thereof and retains the upper punches 5 in a vertically slidable condition and a die portion 33 that is provided at a lower side portion thereof and retains the lower punches 6 in a vertically slidable condition and provided with multiple die mounting holes for mounting the dies 4 detachably at positions facing to the upper punch retain portion 32 on the same circumference of a circle as that of the upper punch retain portion 32.

Multiple punch retaining holes that slidably hold the upper punches 5 are arranged on the upper punch retain portion 32 and multiple punch retaining holed that slidably hold the lower punches 6 are arranged on the die portion 33. Each of the punch retaining holes and the die mounting holes are arranged so that centers of the lower punch 6, the upper punch 5 and the die 4 coincide with each other longitudinally on the rotary table 3.

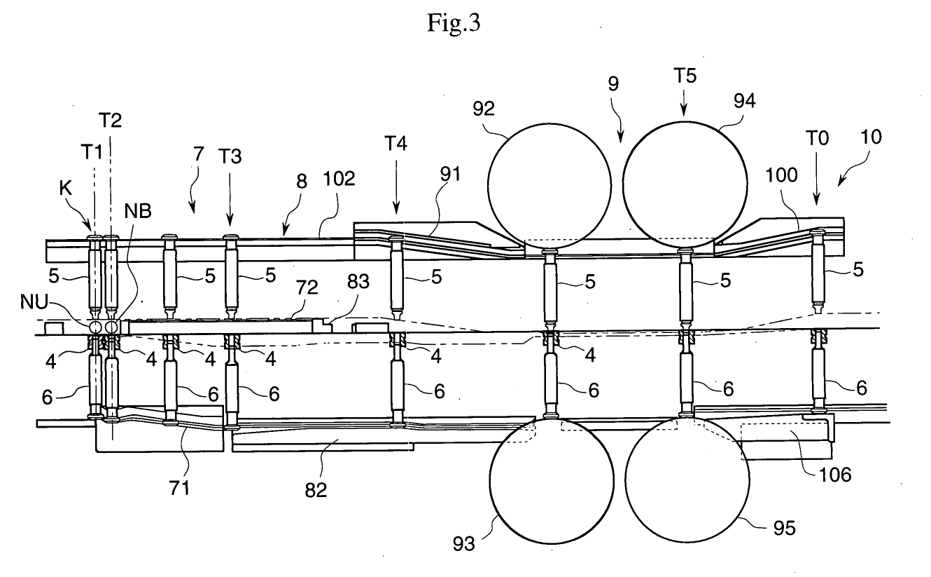

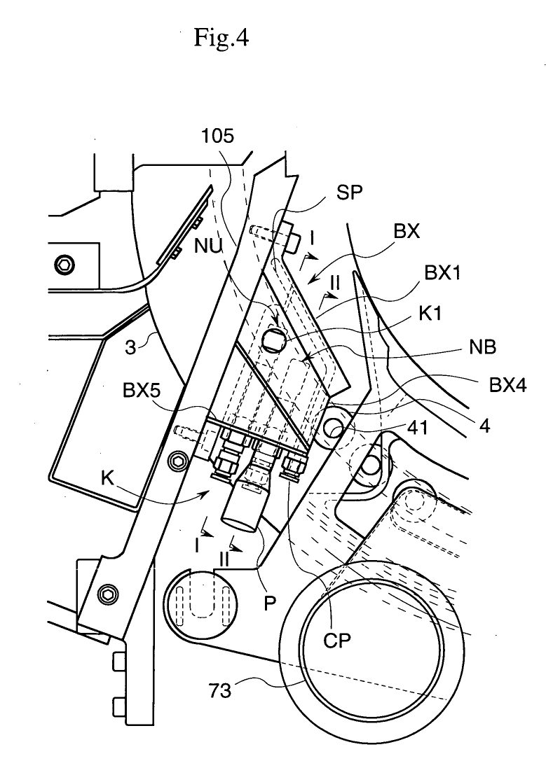

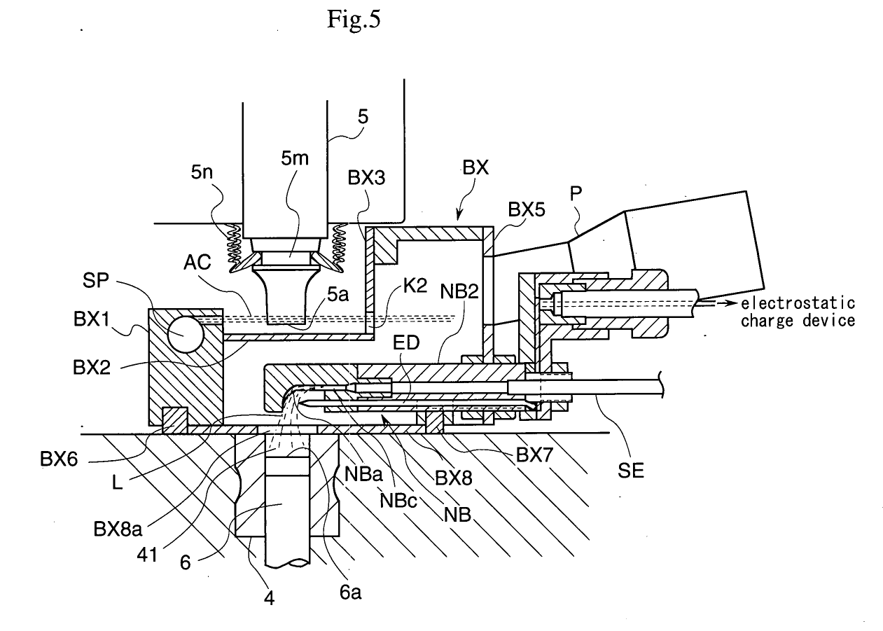

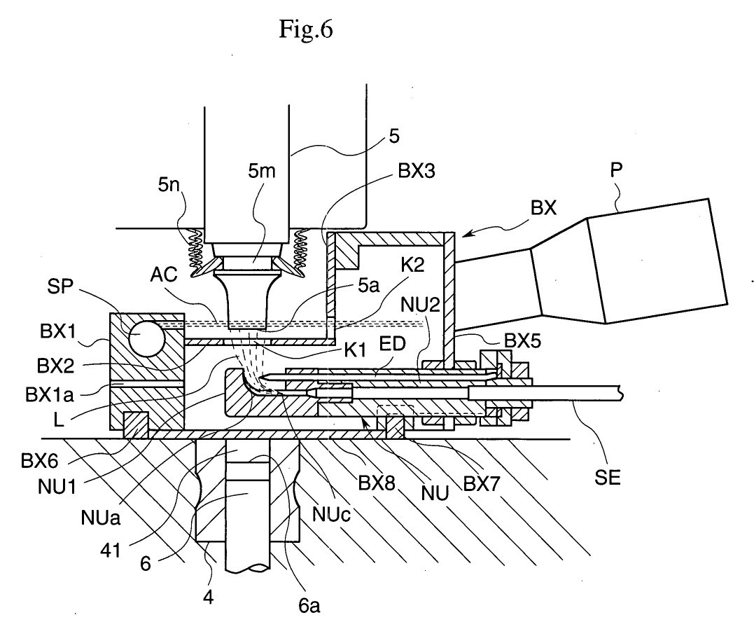

A big diameter portion is provided, as shown in FIG. 3, at an upper end portion of the upper punch 5 and a lower end portion of the lower punch 6 respectively and each of the upper punch 5 and the lower punch 6 is so arranged to make an up-and-down movement with its big diameter portion engaged and guided by a cam which will be described later. Longitudinally penetrating die holes 41 are provided on the dies 4 in order to insert a tip of the upper punch 5 or the lower punch 6. At a lower end portion of the upper punch 5 provided is a bellow 5n whose upper end is fixed to the lower end face of the upper punch retain portion 32 and whose lower end fits into a circular groove 5m arranged at a lower end portion of the upper punch 5 and that covers a trunk portion of the upper punch 5 when the upper punch 5 projects out of the die hole 41 so as not to adhere powder lubricant L that will be described later to the trunk portion of the upper punch 5. (FIG. 5)

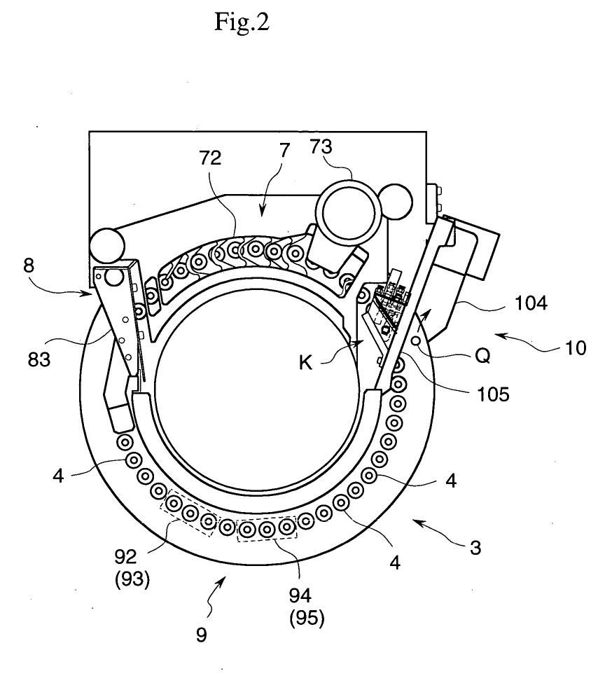

The rotary compressive molding machine for powder material is, as shown in FIG. 2 and FIG. 3, provided with a powder fill portion 7, a powder level portion 8, a compressive mold portion 9, a product unload portion 10 and a powder lubricant spray portion K sequentially along the direction of rotation.

The powder fill portion 7 introduces powder material that has been supplied on the rotary table 3 into the die 4 through a feed shoe 72 by lowering the lower punch 6 with a lowering device 71. The powder material is supplied on the rotary table 3 by means of a powder material supplying mechanism 73.

The powder level portion 8 raises the lower punch 6 to a predetermined level by means of a quantity setting rail 82 and removes the powder material that has overflowed from the die 4 due to a rise of the lower punch 6 by means of a leveling plate 83.

The compressive mold portion 9 comprises an upper punch lowering cam 91 that lowers the upper punch 5 along a descending slant face so as to insert a lower tip of the upper punch 5 into the die 4, upper and lower preliminary compressive rollers 92, 93 preliminarily compress the powder material filled in the die 4 with the upper and lower punches 5, 6 each of whose lower and upper tips is inserted into the die 4 pushed from upside and downside to approach each other and upper and lower compressive rollers 94, 95 that compress the powder material in the die 4 with the upper and lower punches 5, 6 pushed from upside and downside to approach each other in a full-scale manner.

The product unload portion 10 comprises, as shown in FIGS. 2 and 3, an upper punch raising cam 100 that raises the upper punch 5 along a rising slant face so as to draw the tip of the upper punch 5 out of the die 4, a pushing up rail 106 that urges the lower punch 6 upward so that a product Q in the die 4 can be completely pushed out of the die 4 and a guide plate 105 that guides the tablet PL aside so as to introduce the product Q into a shoot 104.

The powder lubricant spray portion K is arranged between the product unload portion 10 and the power fill portion 7. The powder lubricant spray portion K is, as shown in FIG. 5, to supply the powder lubricant L to a lower end face 5a of the upper punch 5, an upper end face 6a of the lower punch 6 and an inner face of the die hole 41 by preventing the powder lubricant L from scattering and has a box body BX that surrounds space where the powder lubricant L is continuously sprayed except for a through hole K1 into which the powder lubricant L for the upper punch 5 passes and except for an inlet K2 into which an air curtain AC as a air current is inhaled, wherein a distal end of an upper nozzle NU that sprays the powder lubricant L into the upper punch 5 and a distal end of the lower nozzle NB that sprays the powder lubricant L into the lower punch 6 and the die hole 41 are included in the box body BX and the air curtain AC is sprayed toward the inlet K2 with passing over the through hole K1.

More specifically, in the powder lubricant spray portion K, the powder lubricant spraying means that supplies the powder lubricant L to the upper punch 5, the lower punch 6 and the die hole 41 comprises, as shown in FIG. 5˜FIG. 9, the upper nozzle NU and the lower nozzle NB as a spraying nozzle that has a concave face NUa, NBa and that faces to the lower end face 5a of the upper punch 5 and the upper end face 6a of the lower punch 6 respectively at a position where the powder lubricant L is supplied and sprays the powder lubricant L generally into one direction guided by the concave face NUa, NBa and an air current supplying mechanism ACS that generates the air curtain AC to prevent superfluous powder lubricant L sprayed through the upper nozzle NU and the lower nozzle NB from scattering upward by spraying an air current into near of the lower end face 5a of the upper punch 5. The upper nozzle NU and the lower nozzle NB are mounted on the box body BX and connected to the device LS for spraying powder lubricant that measures an extremely subtle quantity of the powder lubricant L and that sends the measured powder lubricant L by making use of pressurized gas.

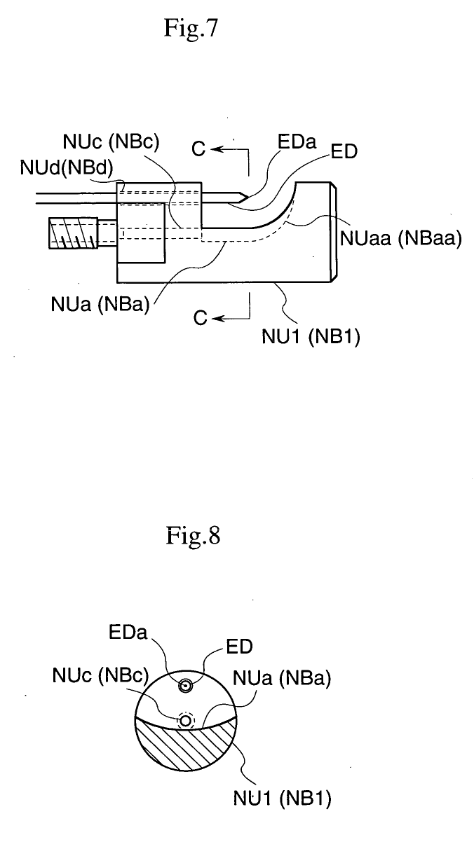

The upper and lower nozzles NU, NB are made of, for example, fluorocarbon resin and the distal end NU1, NB1 of the upper and lower nozzles UN, NB can be dismounted from a nozzle body NU2, NB2. The powder lubricant L is supplied to the upper and the lower nozzles NU, NB by a piping member, in other words, a hose SE made of, for example, fluorocarbon resin. As shown in FIG. 7 and FIG. 8, the distal end NU1, NB1 has a concave face NUa, NBa consisting of a three dimensional face and is provided with an introductory hole NUc, NBc that passes the concave face NUa, NBa. An inner face of the introductory hole NUc, NBc is not flat to the concave face NUa, NBa and opens toward a side of the concave face NUa, NBa so that a slight step is formed between the concave face NUa, NBa and the inner face of the introductory hole NUc, NBc. In accordance with the arrangement, the powder lubricant L is introduced into an intended direction without attaching to the concave face NUa, NBa when sprayed. Each of the concave faces NUa, NBa of the distal end NU1, NB1 of the upper and lower nozzles NU, NB is mounted so as to face the upper punch 5 and the lower punch 6 respectively. More specifically, the distal end NU1 of the upper nozzle NU is mounted with its concave face NUa facing upward in a condition that its mounting shaft is parallel to the rotary table 3. The distal end NB1 of the lower nozzle NB is mounted with its concave face NBa facing downward as well as the upper nozzle NU. A distal end side portion of the concave face NUa of the upper nozzle NU is arranged to locate just under the through hole K1.

An electrode ED made of, for example, stainless-steel to electrize the powder lubricant L is provided to each of the lower nozzle NB and the upper nozzle NU. More specifically, a through hole NBd, NUd that is parallel to the introductory hole NBc, NUc is arranged on the distal end NB1, NU1 of the nozzle NB, NU and the nozzle body NB2, NU2 and the round bar shaped electrode ED is inserted into the through hole NUd, NBd. A distal end EDa of the electrode ED is circular conic or needle-like pointed and locates on an extension of a central axis line.

The through hole NUd, NBd into which the electrode ED is inserted reaches from an end portion locating at a side of mounting the nozzle body NB2, NU2 to a wall face facing to the concave face NBa, NUa of the distal end NB1, NU1. The through hole NUd locates above the introductory hole NUc when the upper nozzle NU is mounted. The through hole NBd locates under the introductory hole NBc when the lower nozzle NB is mounted.

The electrode ED is inserted into the through hole NUd, NBd of the above arrangement from the side of mounting the nozzle body NB2, NU2 until its distal end EDa projects into a space formed by the concave face NBa, NUa so as to be mounted to face to an inclined face NBaa, NUaa across a center axial line of the through hole NUd, NBd of the concave face NBa, NUa. An electric field is formed between the distal end EDa and the inclined face NBaa, NUaa of the concave face NBa, NUa by impressing a high voltage to the electrode ED.

The box body BX is made of, for example, fluorocarbon resin and fixed to a surface facing to the feed shoe 72 of the guide plate 105 in a state electrically-isolated from the rotary table 3. The box body BX comprises a first side wall BX1 inside of which a supplying pipe SP for air of the air curtain AC is arranged and that is provided with an air intake BX1a, a first upper wall BX2 that is horizontally fixed to the first side wall BX1 and at a position of which corresponding to the upper punch 5 arranged is the through hole K1, a second upper wall BX3 that is arranged continuous to the first upper wall BX2 and at a position near the first upper wall BX2 provided is the inlet K2 to which the air curtain AC is guided, a second side wall BX4 that has a guide pipe to guide the air for the air curtain AC to the supplying pipe SP and that is fixed to the first side wall BX1 so as to be parallel to the guide plate 105, a third side wall BX5 that is mounted on the second side wall BX4 at generally a right angle in a plane view, elastic members BX6 and BX7 each of which has an electrical insulation performance and seals a gap between the rotary table 3 and the first side wall BX1, a gap between the rotary table 3 and the upper nozzle NU and a gap between the rotary table 3 and the lower nozzle NB respectively and the bottom plate BX8 made of, for example, fluorocarbon resin that is arranged inner side of the elastic members BX6 and BX7 to block a bottom portion of the box body BX.

The upper nozzle NU, the lower nozzle NB and a pipe P for picking up dust are mounted on the third side wall BX5 of the box body BX. A connect portion CP to introduce air for the air curtain AC is mounted on an end face of the second side wall BX4 through the third side wall BX5. At a portion of the bottom plate BX8 corresponding to a track of the die 4 provided is a feed hole BX8a that has a diameter a little larger than that of the die hole 41 and into which the powder lubricant L sprayed from the lower nozzle NB passes. Since the powder lubricant L adheres to a toric portion having a width of the feed hole BX8a alone on the rotary table 3 due to the bottom plate BX8, it is possible to keep a quantity of the powder lubricant L adheres to the rotary table 3 to a minimum. The connect portion CP is connected to an air compressor, not shown in drawings, to generate pressurized air for forming the air curtain AC and an air current supplying mechanism ACS comprises the air compressor, the supplying pipe SP and the connect portion CP. The pipe P for picking up dust is connected to a dust pick-upper LS5 and constitutes a powder sucking mechanism together with the box body BX.

The device LS for spraying powder lubricant comprises, as shown in FIG. 9, a powder lubricant supply portion LS1 that sends out the powder lubricant L attaching to an outer face of a rotary drum D driven by a motor M by means of an air current, a flow quantity detect portion LS2 that detects a flow quantity of the powder lubricant L that is sent out from the powder lubricant supply portion LS1, a retrieved quantity detect portion LS3 that detects a retrieved quantity of the powder lubricant L that is sprayed from the upper and the lower nozzles NU, NB and that does not attach to either the upper punch 5, the lower punch 6 or the die hole 41, a control portion LS4 that controls the powder lubricant supply portion LS1 based on a quantity of the powder lubricant L detected by the flow quantity detect portion LS2 and the retrieved quantity detect portion LS3, a dust pick-upper LS5 constituting the powder sucking mechanism and an electrostatic charge device CD that electrizes the powder lubricant L.

The powder lubricant supply portion LS1 sends out a small quantity of the powder lubricant L, for example, by 5˜25 gram per hour through a supply pipe line LS6 to the flow quantity detect portion LS2. The flow quantity detect portion LS2 detects a flow quantity of the powder lubricant L, for example, chemically by means of a low angle light spread method and electrically by means of an electrical capacitance method. The control portion LS4 calculates a difference between the quantity detected by the flow quantity detect portion LS2 and a quantity detected by the retrieved quantity detect portion LS3. The flow quantity of the powder material L is feedback controlled so as to be a predetermined quantity based on the result of the above calculation.

The supply pipe line LS6 comprises an inner pipe LS6a made of insulating material, for example, fluorocarbon resin in order to prevent the powder lubricant L from adhering to the supply pipe line LS6 and a shield member LS6b made of electrically conductive material, for example, aluminum that covers an outer side of the inner pipe LS6a. The shield member LS6b is connected to ground electrically. Due to an arrangement wherein the supply pipe line LS6 comprises the inner pipe LS6a and the shield member LS6b, it is possible to prevent the powder lubricant L from being charged with electricity when the powder lubricant L passes inside the inner pipe LS6a by friction between the powder lubricant L and the inner pipe LS6a. As a result of this, it is possible to avoid a case that the powder lubricant L can not be supplied smoothly because the powder lubricant L attaches to inside the inner pipe LS6a and that a used quantity of the powder lubricant L can not be calculated accurately because the powder lubricant L that attaches to the inner pipe LS6a can not be retrieved.

The electrostatic charge device CD comprises a power supply portion PS that generates a D.C. voltage of, for example, 100 KV, a high voltage generatrix HV that transforms the D.C. voltage output by the power supply portion PS into a high voltage and the electrode ED on which the D.C. high voltage output by the high voltage generatrix HV is impressed. The power supply portion PS is so arranged to change an output voltage continuously up to 100 KV. The high voltage generatrix HV is connected with an output terminal with a negative voltage of the power supply portion PS. Then the negative voltage is impressed on the electrode ED by connecting the high voltage generatrix HV with the electrode ED serially. An output terminal with a positive voltage of the power supply portion PS is electrically connected with the upper punch 5, the lower punch 6 and the die 4 including the rotary table 3. As a result, the upper punch 5, the lower punch 6, the die 4 and the rotary table 3 are in a positive high voltage against the electrode ED.

In the device LS for spraying powder lubricant, the powder lubricant supply portion LS1 and the power supply portion PS of the electrostatic charge device CD are arranged outside of the rotary compressive molding machine for powder material, while the flow quantity detect portion LS2, the retrieved quantity detect portion LS3, the control portion LS4, the dust pick-upper LS5 and the electrode ED constituting the electrostatic charge device CD are arranged inside the rotary compressive molding machine for powder material.

In accordance with the arrangement, when the device LS for spraying powder lubricant is turned on to spray the powder lubricant L, the electrode ED is in a negative high voltage against the upper punch 5, the lower punch 6, the die 4 and the rotary table 3. In this case, if the power supply portion PS is adjusted to fix the negative high voltage impressed on the electrode ED at a voltage value of 40˜60 KV, for example, 50 KV, a non-uniform electric field is formed in a space between the electrode ED and the concave face NBa, NUa. The reason is that the lower nozzle NB and the upper nozzle NU are electronegative against the electrode ED because they are made of fluorocarbon resin and voltage values of the lower nozzle NB and the upper nozzle NU are relatively low compared with the voltage value impressed on the electrode ED so that there is a potential difference, for example, about 49 KV between the lower nozzle NB (the upper nozzle NU) and the electrode ED.

When the powder lubricant L is sprayed into the space between the concave face NUa, NBa of the distal end NU1, NB1 and the electrode ED in case that the non-uniform electric field is formed in the space, the powder lubricant L is further electrized negatively while the powder lubricant L passes the non-uniform electric field. In this embodiment, since the lower nozzle NB and the upper nozzle NU are made of fluorocarbon resin and the piping member for supplying the powder lubricant L to the lower nozzle NB or the upper nozzle NU is the hose SE made of fluorocarbon resin, the powder lubricant L is electronegative by friction against the fluorocarbon resin. The powder lubricant L is further electrized negatively, in other words, electrized negatively to a high voltage by passing the non-uniform electric field formed between the electrode ED and the concave face NBa, NUa immediately after sprayed from the distal end NB1 of the lower nozzle NB and the distal end NU1 of the upper nozzle NU.

The upper punch 5, the lower punch 6 and the die 4 to which the powder lubricant L is sprayed are electrized higher than the powder lubricant L electrized by the electrostatic charge device CD, in other words, electrized positively. Then when the electronegative powder lubricant L is sprayed to the upper punch 5, the lower punch 6 and the die 4, the powder lubricant L is attracted to a direction of the upper punch 5, the lower punch 6 and the die 4 respectively by an electrostatic force so as to electrostatically attach to each target surface, in other words, the lower end face 5a of the upper punch 5, the upper end face 6a of the lower punch and the inner face of the die hole 41 of the die 4. The powder lubricant L that has once attached to the target face of the upper punch 5, the lower punch 6 and the die 4 does not detach from the target face because the powder lubricant L remains to attach electrostatically. As a result of this, it is possible to effectively prevent the powder material from attaching to the lower end face 5a of the upper punch 5, the upper end face 6a of the lower punch and the inner face of the die hole 41 of the die 4 when the powder material is compressed and molded. If at all the powder lubricant L detaches from the target face, the quantity of the powder lubricant L that attaches to the target face itself is extremely slight, thereby to keep the quantity of the powder lubricant L that is mixed into the powder material to be compressed and molded to the minimum and to prevent an effect on hardness of a molded item.

In accordance with the arrangement, the power lubricant L is sprayed at a timing that will be explained hereinafter. The timing of spraying the powder lubricant L will be explained with reference to FIG. 3 together with a process to mold a tablet. Each of T0˜T5 in FIG. 3 means a phase. The upper and the lower punches 5, 6 are kept at the highest position in a step of passing the product unload portion 10 (T0). Next, the upper and the lower punches 5, 6 move to the lubricant spray portion K with a rotation of the rotary table 3 with the position of the upper and the lower punches 5, 6 kept at the highest position (T1). At this position, the powder lubricant L is sprayed to the upper punch 5. Next, when the rotary table 3 rotates, the lower punch 6 is lowered by an amount corresponding to a thickness of the product Q at a front end portion of the lowering device 71. At this position, the power lubricant L is sprayed to the lower punch 6 and the die 4 (T2). As a result of this, the powder lubricant L can adhere to the upper end face 6a of the lower punch 6 and the inner face of the die hole 41 by a depth corresponding to the thickness of the product Q.

As mentioned above, since the powder lubricant L is sprayed from the upper nozzle NU when the upper punch 5 is kept at the highest position, the sprayed powder lubricant L intensively adheres electrostatically to the lower end face 5a of the upper punch 5. More specifically, since the powder lubricant L is electronegative due to the electrostatic charge device CD and the lower end face 5a of the upper punch 5 is electropositive, the powder lubricant L is gravitated and adheres electrostatically to the lower end face 5a of the upper punch 5.

Then since the lower punch 6 paired with the upper punch 5 and the die 4 pass below the lower nozzle NB with the above-mentioned position kept, the powder lubricant L sprayed from the lower nozzle NB adheres to the lower punch 6 and the inner face of the die hole 41. More specifically, since the lower end face 5a of the upper punch 5 is electropositive due to the electrostatic charge device CD, the electronegative powder lubricant L is gravitated and adheres electrostatically to the upper end face 6a of the lower punch 6 and the inner face of the die hole 41.

Since the powder lubricant L is guided by the concave face NUa of the upper nozzle NU and the concave face NBa of the lower nozzle NB and sprayed, the powder lubricant L diffuses in a generally even state toward the lower end face 5a of the upper punch 5, the upper end face 6a of the lower punch 6 and the inner face of the die hole 41. More specifically, since the concave face NUa, NBa is a three dimensional curved surface, in case the powder lubricant L is sprayed from the introductory hole NUc, NBc and collides against the concave face NUa, NBa, the powder lubricant L travels along the concave face NUa, NBa in a direction of spraying the powder lubricant L from the introductory hole NUc, NBc and a direction that crosses the above direction. In a case of the upper nozzle NU, since the concave face NUa faces to the through hole K1 locating just above the concave face NUa, the powder lubricant L passes the through hole K1 and reaches the lower end face 5a of the upper punch 5. In a case of the lower nozzle NB, the powder lubricant L guided by the concave face NBa reaches directly the upper end face 6a of the lower punch 6 and the inner face of the die hole 41. As a result of this, the powder lubricant L adheres generally evenly to general whole area of the lower end face 5a of the upper punch 5, the upper end face 6a of the lower punch 6 and the inner face of the die hole 41 by a predetermined depth. In this case, since the air curtain AC exists above the lower end face 5a of the upper punch 5 to cut across the upper punch 5, the powder lubricant L that does not attach to the lower end face 5a of the upper punch 5 reaches the inlet K2 along the air current of the air curtain AC and is retrieved from the pipe P by the dust pick-upper LS5 through the retrieved quantity detect portion LS3. For a case of the lower nozzle NB, since the concave face NBa faces downward, the superfluous powder lubricant L that is bounced against the upper end face 6a of the lower punch 6 and the rotary table 3 flows into the pipe P along the first upper wall BX2 and the powder lubricant L that flows out of the through hole K1 flows into the pipe P through the inlet K2 by the air current of the air curtain AC like the case of the upper nozzle NU.

Next, when the lower punch 6 moves to the powder fill portion 7 due to a rotation of the rotary table 3, the lower punch 6 is first lowered to a middle position under the guidance of a front half portion of the lowering device 71 and then lowered to a further lower position under the guidance of a rear half portion thereof (T3). On its way the powder material supplied on the rotary table 3 by the powder material supplying mechanism 73 is evenly introduced by making use of guidance by the feed shoe 72. Then the lower punch 6 runs up onto a quantity setting rail 82, which raises the lower punch 6 until it reaches a predetermined height and a predetermined quantity of the powder material is filled into the die 4. The powder material that has overflowed out of the die 4 is leveled when it passes the leveling plate 83 and gathered toward the center of the rotary table 3. During this process, the upper punch 5 is kept at the highest position by a guide rail 102.

Next, the upper punch 5 is lowered (T4) under the guidance of the upper punch lowering cam 91 so as to insert the tip of the upper punch 5 into the die 4. Then the powder material in the die 4 is compressed and molded into the product Q by the upper and lower punches 5, 6 that pass between the upper and lower preliminary compressive rollers 92, 93 and the upper and lower compressive rollers 94, 95 (T5).

After the product Q is molded, in the product unload portion 10, the upper punch 5 is raised under the guidance of the upper punch raising cam 100 so as to be withdrawn out of the die 4, and then the product Q in the die 4 is pushed upward so as to come out on the rotary table 3 by the lower punch 6 pushed up by the pushing up rail 106. The product Q is guided onto a shoot 104 by the guide plate 105 and introduced out of the rotary compressive molding machine for powder material. Next, the upper punch 5 is further raised under the guidance of the upper punch raising cam 100. As mentioned above, the rotary compressive molding machine for powder material can produce a predetermined product Q repeatedly and successively with the powder material compressed and molded.

In accordance with thus arranged rotary compressive molding machine for powder material of this embodiment, since the powder lubricant L is guided by the concave face NUa of the upper nozzle NU and the concave face NBa of the lower nozzle NB and sprayed to a portion that contacts with the powder material, namely, the lower end face 5a of the upper punch 5, the upper end face 6a of the lower punch 6 and the inner face of the die hole 41 every time prior to tableting, the powder lubricant L attaches to the portion in a generally uniform condition by an electrostatic force and a sticking phenomenon can be prevented surely. In addition, since the sprayed powder lubricant L is in a small quantity and minimum required in order to prevent a sticking phenomenon, it is possible to manufacture tablets made of powder material into which the powder lubricant L is not mixed with enough hardness.

Further, the air curtain AC and the bellow 5n are arranged near the bottom end portion of the upper punch 5 in the powder lubricant spray portion K, it is possible to prevent the powder lubricant L that leaks from the box body BX of the powder lubricant spray portion K from unnecessarily attaching to the upper punch 5. In addition, since the powder lubricant L is sprayed at a small quantity near the end face of the upper punch 5 and the lower punch 6 and the superfluous powder lubricant L is retrieved by making use of the air current of the air curtain AC, it is possible to prevent the superfluous powder lubricant L from scattering certainly. In addition, since the powder lubricant L is kept in a condition of attaching to the inner face of the die hole 41, it is possible to reduce a consumed quantity of the powder lubricant L.

This invention is not limited to the above-explained embodiments.

The high voltage impressed on the electrode ED may be set in accordance with an aspect of the powder lubricant L to be used. More concretely, the voltage is set low for the powder lubricant L whose particle size is small, while the voltage is set high for the powder lubricant L whose particle size is big. Then it is possible to make the quantity of the powder lubricant L that electrostatically attaches to the target face generally even irrespective of varieties of the powder lubricant L.

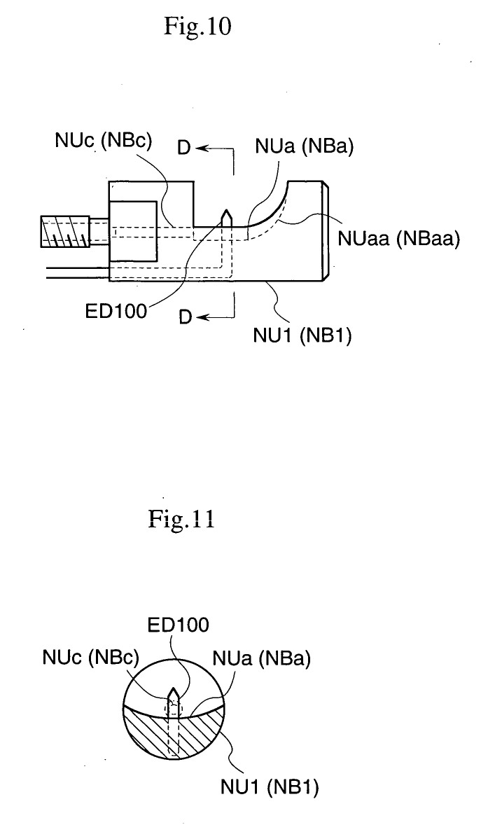

In addition, the electrode ED100 may be, as shown in FIG. 10 and FIG. 11, arranged at a general center portion of each concave face NUa, NUb of the nozzle NU, NB to project toward a direction to which the powder lubricant L is sprayed. A distal end of the electrode ED100 may be in the same shape as that of the above embodiment. Take the upper nozzle NU for instance, the projecting portion of the electrode ED100 projects generally vertically to a bottom face of the concave face NUa, however, the distal end of the projecting portion may be arranged to incline toward the inclined face side of the concave face NUa.

In the above embodiment explained is the compressive molding machine wherein a single kind of powder material is compressed and molded, however, the compressive molding machine may mold a tablet having a core tablet comprising different kind of powders or a molded product general center portion of which a through hole is formed.

In addition, to punch a mark such as a mark or a character of a manufacturer on a surface of a molded product the upper punch and the lower punch may have a convex portion or a concave portion corresponding to the mark. Since the powder lubricant electrostatically attaches to the end face of the upper and lower punches by the electrostatic force, it is possible for the powder lubricant to attach this kind of the upper punch or the lower punch having the convex or concave portion like the upper and lower punches having no convex or concave portion.

Next, another embodiment of the present claimed invention will be explained. In the following explanation, an explanation for the same arrangement will be omitted and the same numerical code is given to the same component.

When the powder lubricant L is sprayed continuously like the above embodiment, a little residual powder lubricant L might be left in a toric shape of a diameter of the feed hole BX8a on the rotary table 3. In order to further reduce an amount of the residual powder lubricant L, it is preferable that an insulating layer IL is formed on an upper face 33a of a die portion 33 of the rotary table 3 so as to prevent the powder lubricant L from being sucked by the rotary table 3 and to retrieve the residual powder lubricant L by removing electrostatic charge from the residual powder lubricant L. A concrete arrangement will be explained as follows.

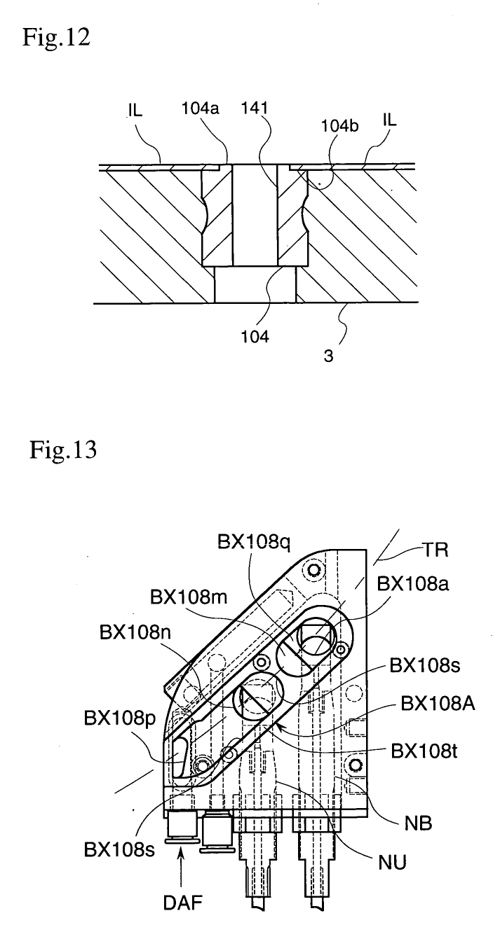

The rotary table 3 itself is made of metal, for example, stainless steel. Then the upper face 33a of the die portion 33 is covered with the insulation layer IL made of an insulating material, for example, ceramics as shown in FIG. 12 in order to restrain the powder lubricant L from attaching to the rotary table 3. This makes it possible to restrain the powder lubricant L from attaching to the upper face 33a of the die portion 33 of the rotary table 3 in case the powder lubricant L is continuously sprayed to the upper face 33a of the die portion 33 of the rotary table 3 including the die 104. Instead of the ceramics, for example, fluorocarbon resin may be applied to form the insulation layer IL on the upper face 33a of the die portion 33.

An upper face of the die 104 is also covered with the insulation layer IL made of ceramics. This insulation layer IL may be integrally formed into the insulation layer IL of the die portion 33 or may be formed with respect to each die 104. A toric step portion 104b is arranged to form a metal exposure portion 104a that exposes metal in a toric shape of a predetermined width around a die hole 141 of the upper face of the die 104 in order to form the insulation layer IL on the upper face of the die 104. A depth of the step portion 104b is generally the same as a thickness of the insulation layer IL. In addition, the thickness of the insulation layer IL is generally the same as a thickness of the insulation layer IL of the die portion 33. As a result, the upper face of the insulation layer IL is generally flat to the upper face of the metal exposure portion 104a. The metal exposure portion 104a makes the charged powder lubricant L easy to be sucked toward a direction of the die hole 141. The insulation layer IL of the upper face of the die 104 may be of, for example, fluorocarbon resin.

As mentioned above, it is possible to minimize an amount of the superfluous residual powder lubricant L remaining on the rotary table 3 by forming the insulation layer IL on generally the whole of the rotary table 3 and the upper face of the die 104. In addition, since the toric metal exposure portion 104a exists around the die hole 141 of the upper face of the die 104, it is possible for the powder lubricant L to effectively attach to the die hole 141 in spite of the insulation layer IL formed on the upper face of the die 104.

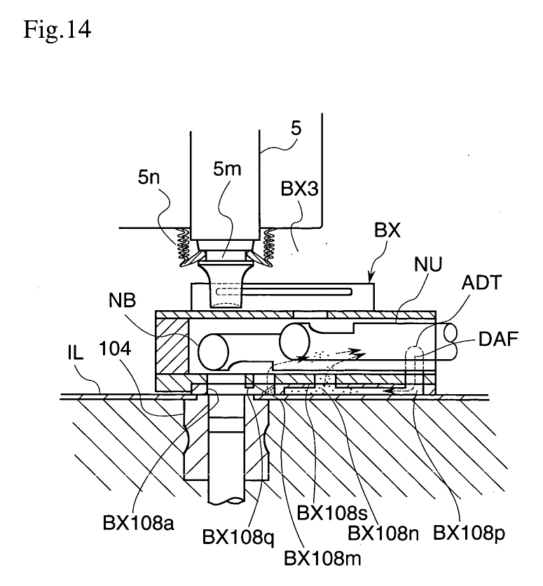

The box body BX of the powder lubricant spray portion K in accordance with this embodiment has an arrangement wherein whole of the bottom face of the bottom plate BX8 contacts the upper face 33a of the rotary table 3 on a full-time basis, however, in order to improve durability the arrangement is so made that a portion of the bottom face of the bottom plate BX8 corresponding to a track TR of the die 104 alone contacts the upper face 33a. An example wherein a shape of the bottom face of the bottom plate BX8 of the box body BX is changed will be explained with reference to FIG. 13 and FIG. 14.

The box body BX has an arrangement wherein a portion of the bottom face of the bottom plate BX108 corresponding to the track TR of the die 104 projects downward relative to other portion. More specifically, a projecting portion BX108A is detachably formed at a portion that contacts the upper face 33a of the rotary table 3 and a bottom face of a portion surrounding the projecting portion BX108A is so made higher than the projecting portion BX108A not to contact the upper face 33a. A feed hole BX108a through which the powder lubricant L passes is arranged at a portion of the projecting portion BX108A corresponding to the lower nozzle NB of the box body BX and a first inlet BX108m and a second inlet BX108n to suck the residual powder lubricant L left on the upper face 33a of the rotary table 3 of the track of the die 104 of and an air nozzle BX108p are provided. In the following explanation, a direction from which the die 104 approaches viewed from the projecting portion BX108A is assumed as upstream and a direction to which the die 104 moves away is assumed as downstream.

The feed hole BX108a is arranged at an end portion of an upstream side of the projecting portion BX108A. In a downstream side of the feed hole BX108a a first thin portion BX108q is formed continuously with the feed hole BX108a. In a downstream side of the first thin portion BX108q arranged is the first inlet BX108m whose plane shape is semicircular and that is continuous with the first thin portion BX108q and connected through inside the box body BX. A second thin portion BX108s is arranged through a portion that contacts the upper face 33a of the rotary table 3 in a downstream side of the first inlet BX108m. In a downstream side of the second thin portion BX108s arranged is the second inlet BX108n whose plane shape is semicircular and that is connected through inside the box body BX. At an end portion of a downstream side of the second thin portion X108s arranged is the air nozzle BX108p of an air current DAF for discharge electricity to be supplied to the upper face 33a of the rotary table 3 through the box body BX. A contact bottom face BX108t is arranged to surround the feed hole BX108a, the first thin portion BX108q, the second thin portion BX108s and the air nozzle BX108p.

The air current DAF for discharge electricity is charged with a reverse polarity against the electrized powder lubricant L and is to electrically neutralize the powder lubricant L, namely, to make the powder lubricant L in a state of not being electrized by contacting the electrized powder lubricant L left on the upper face 33a of the rotary table 3. The air current DAF for discharge electricity is produced by passing air through an electric field formed by electrode charged with a reverse polarity against the powder lubricant L. The air current DAF for discharge electricity is lead into the box body BX through a pipe line from a unit for generating air current for discharge electricity, not shown in drawings, and blasted from the air nozzle BX108p through an air duct ADT in the box body BX.

Since the above-mentioned projecting portion BX108A contacts the rotary table 3 through the toric contact bottom face BX108t alone, a durability of the rotary table 3 and the box body BX can be improved. In addition, since the first inlet BX108m, the second inlet BX108n and the air nozzle BX108p are provided, it is possible to take the powder lubricant L left around the die 104 of the rotary table 3 effectively into the box body BX. More specifically, the powder lubricant L left on the upper face 33a of the rotary table 3 is gathered and drawn into the first inlet BX108m when a portion between the first inlet BX108m and the second thin portion BX108s contacts the upper face 33a of the rotary table 3.

At the same time, the powder lubricant L left on the upper face 33a of the rotary table 3 that has been discharged and flown up by contacting the air current DAF for discharge electricity sprayed from the air nozzle BX108p is filled into the second thin portion BX108s. Since the second thin portion BX108s is surrounded by the contact portion BX108t, the powder lubricant L that has been flown up does not scatter outside and is drawn into the box body BX through the second inlet BX108n. As a result, it is possible to retrieve most of the powder lubricant L left on the upper face 33a of the rotary table 3 except for the powder lubricant L attaching to the die hole 141.

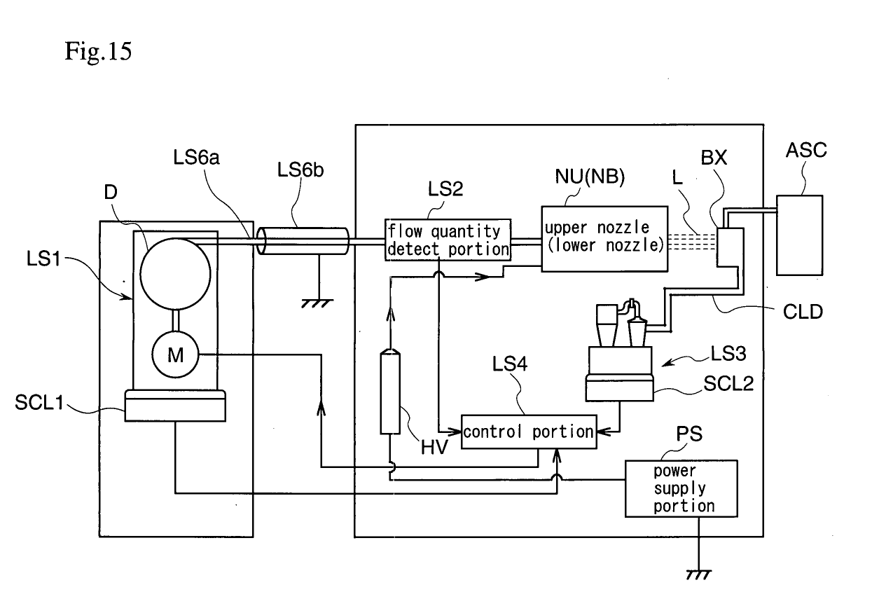

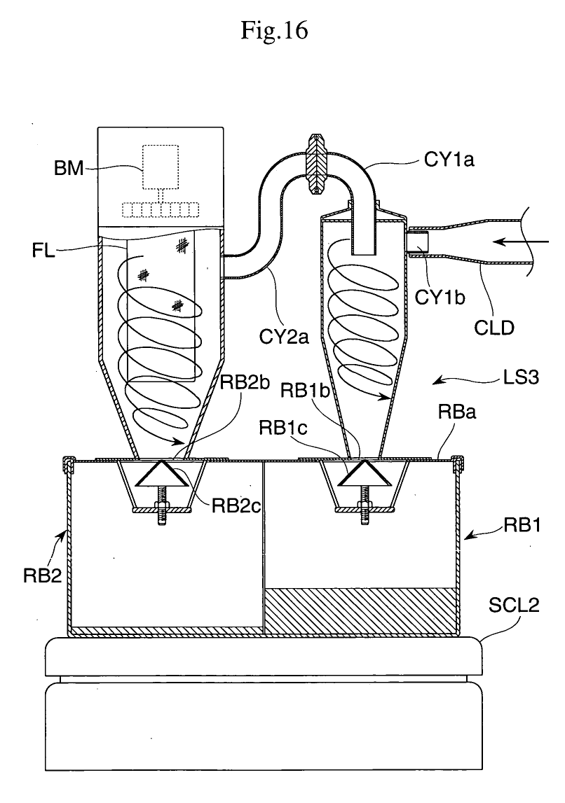

In measuring an amount of the powder lubricant L, a weight meter, more concretely, an electronic scale SCL1, SCL2 (hereinafter referred to as a scale) may be used in addition to the above-mentioned optical scale. An embodiment using the scale SCL1, SCL2 will be explained with reference to FIG. 15 and FIG. 16. In this embodiment, the above-mentioned optical flow quantity detect portion LS2 may be omitted. In case the flow quantity detect portion LS2 is not omitted, the flow quantity detect portion LS2 detects whether the powder lubricant L flows or not based on the signal output from the flow quantity detect portion LS2. More specifically, the flow quantity detect portion LS2 may be utilized to detect malfunction of the device LS for spraying powder lubricant such that the powder lubricant L does not supply.

The amount of the powder lubricant L is measured by the scale SCL1 locating in a supply side to measure weight of the powder lubricant supply portion LS1 that supplies the powder lubricant L and the scale SCL2 locating in a retrieve side to measure weight of the retrieved quantity detect portion LS3 in order to measure weight of the retrieved powder lubricant L.

The powder lubricant supply portion LS1 is placed on the scale SCL1 locating in the supply side and the scale SCL1 is adjusted by making use of allowance for tare of the weight of the powder lubricant supply portion LS1. In this case, the powder lubricant supply portion LS1 is connected with the supply pipe line LS6 in a floating state not to be affected by an outer force through the supply pipe line LS6. More specifically, the powder lubricant supply portion LS1 and the supply pipe line LS6 is connected through a small gap so as to block an outer force resulting from a phenomenon such that the supply pipe line LS6 is vibrated or deformed due to some cause and not to transmit the outer force to the powder lubricant supply portion LS1. Since the gap is formed by connecting the supply pipe line LS6 around a portion of an output pipe of the powder lubricant supply portion LS1, the outgoing powder lubricant L does not leak from this gap. With this arrangement, it is possible to prevent tare of the powder lubricant supply portion LS1 from being affected.

The retrieve quantity detect portion LS3 includes a first cyclone CY1, a second cyclone CY2 to be connected to the first cyclone CY1, a first retrieve container RB1 that accommodates the powder lubricant L retrieved by the first cyclone CY1 and the second retrieve container RB2 that accommodates fine particle powder including the powder lubricant L retrieved by the second cyclone CY2. The retrieve quantity detect portion LS3 is placed on the scale SCL2 locating in the retrieve side.

The first cyclone CY1 and the second cyclone CY2 are communicating through a flanged connecting pipe CY1a arranged at a top portion of the first cyclone CY1 and a link connecting pipe CY2a mounted on a side face upper portion of the second cyclone CY2 and connected to the flanged connecting pipe CY1a. An outer connecting pipe CY1b is arranged at a side face upper portion of the first cyclone CY1 and a retrieve pipe CLD that is communicating with the box body BX of the powder lubricant spray portion K is connected with the outer connecting pipe CY1b not in a closely contact state but in a floating state with a gap formed between the retrieve pipe CLD and the outer connecting pipe CY1b.

Each lower end portion of the first cyclone CY1 and the second cyclone CY1 is connected with a first container RB1 and a second container RB2 respectively. Each of the first container RB1 and the second container RB2 is made of an integrally formed cuboid box and a lid body RBa common to the first container RB1 and the second container RB2 is mounted on an upper face of the cuboid box in a removable condition. Each of the lower end portion of the first cyclone CY1 and the second cyclone CY2 is fixed to an opening RB1b and an opening RB2b formed on the lid body RBa respectively. Conic baffles RB1c, RB2c are arranged at the lower side position of the openings RB1b, RB2b to face to the lower end of the first cyclone CY1 and the second cyclone CY2 so as not to pull back the powder lubricant L retrieved by the first container RB1 and the second container RB2 to a side of the first cyclone CY1 and the second cyclone CY2. Each of the baffles RB1c, RB2c is so made to be able to adjust its height to be mounted.

The second cyclone CY2 has a blower motor BM at its upper portion and a cylindrical filter FL under the blower motor BM and is communicating with the first cyclone CY1 through an upper portion of the side face of the filter FL. The second cyclone CY2 is to retrieve powder lubricant of relatively fine particle that has not been retrieved by the first cyclone CY1. When the blower motor MB is activated, an ascending air current generates from a downside of the filter FL of the second cyclone CY2 and a downward spiral current generates along a side face of the filter FL due to the ascending air current.

When the blower motor BM embedded into the second cyclone CY2 is activated, the retrieve quantity detect portion LS3 retrieves the powder lubricant L into the first container RB1 and the second container RB2 each of which is integrally formed through the box body BX of the powder lubricant spray portion K and the retrieve pipe CLD.

Most of the retrieved powder lubricant L, for example, about 90 through 95% of the retrieved quantity of the powder lubricant L is retrieved into the first container BR1 by the first cyclone CY1 and the powder lubricant of relatively fine particle that has not been retrieved by the first cyclone CY1 is retrieved into the second container BR2 by the second cyclone CY2. The powder lubricant L contacts the outside surface of the filter FL in the second cyclone CY2 and is retrieved into the second container RB2 due to the downward spiral current.

In addition, since the first cyclone CY1 and the second cyclone CY2 are connected with a small gap formed, an outer force is not applied to the first cyclone CY1 when the powder lubricant L is retrieved. In other words, the retrieve pipe CLD does not stick fast to the retrieved quantity detect portion LS3 placed on the scale SCL2 locating in the retrieve side due to a sucking force generating in the first cyclone CY1 and the second cyclone CY2 when the blower motor BM of the second cyclone CY2 is activated. As a result of this, a weight of the retrieved quantity detect portion LS3 can be measured accurately since the retrieved quantity detect portion LS3 is not supported by the retrieve pipe CLD, thereby to prevent tare weight from changing.

In accordance with the arrangement, a used quantity of the powder lubricant L can be calculated by subtracting a weight of the powder lubricant L actually retrieved and measured by the scale SCL2 locating in the retrieve side from a weight of the powder lubricant L measured by the scale SCL1 locating in the supply side by the control portion LS4. Since the scale SCL 2 locating in the retrieve side indicates a sum total of the weight of the retrieved quantity detect portion LS3 and the weight of the retrieved powder lubricant L, the weight of the powder lubricant L actually retrieved is obtained by subtracting the weight indicated by the scale SCL2 locating in the retrieve side from the weight of the retrieved quantity detect portion LS3 as a tare weight. The measurement of the used quantity of the powder lubricant L is conducted every determined interval. The control portion LS4 compares a measured value of the used quantity with a set value of the quantity set according to a speed of the compression of the powder material and controls the powder lubricant supply portion LS1 to decrease the supply quantity of the powder lubricant L in case the used quantity exceeds the set value a supply quantity of the powder lubricant L and to increase the supply quantity of the powder lubricant L in case the used quantity is below the set value.

As mentioned above, it is possible to measure the used quantity of the powder lubricant L accurately by using the scale SCL1 locating in the supply side and the scale SCL2 locating in the retrieve side.

The other arrangement of the component is not limited to the embodiment described in drawings and there may be various modifications without departing from the spirit of the invention.

### POSSIBlE APPLICATIONS IN INDUSTRY

As mentioned above, in accordance with the rotary compressive molding machine for powder material of the present claimed invention wherein powder lubricant is attached to the punch and the die, it is possible to improve an efficiency of attaching the powder lubricant surely and to avoid the powder lubricant from being mixed into a powder material to be compressed and molded almost completely, then the rotary compressive molding machine for powder material is suitable to manufacture tablets or food.

1. A rotary compressive molding machine for powder material wherein a rotary table is rotatably arranged in a frame through an upright shaft, a die having a die hole is arranged on the rotary table, an upper punch and a lower punch are kept above and below the die in a vertically slidable condition and powder material filled in the die hole is compressed and molded between a lower end face of the upper punch and an upper end face of the lower punch by pushing the upper punch and the lower punch so as to approach each other with their tips inserted into the die hole,
comprising a powder lubricant spraying means that sprays powder lubricant to the upper end face of the lower punch, the lower end face of the upper punch and the die hole prior to filling the powder material, and
characterized by that the powder lubricant spraying means comprises a spray nozzle that has a concave face facing to the lower end face of the upper punch or the upper end face of the lower punch at a position where the powder lubricant is sprayed and that sprays the powder lubricant generally toward a direction of the lower end face of the upper punch or the upper end face of the lower punch guided by the concave face,
an air current supply mechanism that prevents the powder lubricant sprayed by the spray nozzle from scattering upward by spraying air near the lower end face of the upper punch, and
an electrostatic charge device that electrizes the powder lubricant when the powder lubricant is sprayed from the spray nozzle and that also electrizes at least the upper punch, the lower punch and the die with an antipolarity against the electrized powder lubricant.

2. The rotary compressive molding machine for powder material described in claim 1 and characterized by that the electrostatic charge device comprises an electrode that forms an electric field where the powder lubricant sprayed from the spray nozzle passes.

3. The rotary compressive molding machine for powder material described in claim 2 and characterized by that the electric field is formed in a space formed by the concave face of the spray nozzle.

4. The rotary compressive molding machine for powder material described in claim 1 and characterized by that the powder lubricant spraying means further comprises a powder sucking mechanism that sucks the powder lubricant that is prevented from moving upward by the air current supply mechanism.

5. The rotary compressive molding machine for powder material described in claim 1 and characterized by that the powder lubricant spray means further comprises a box body that surrounds a position where the powder lubricant is supplied, the concave face of the spray nozzle is arranged in the box body and superfluous powder lubricant scattering out of the box body is sucked by the powder sucking mechanism after passing inside the box body through an air current due to the air current supply mechanism.

6. The rotary compressive molding machine for powder material described in claim 1 and characterized by that the concave face of the spray nozzle is formed in a three-dimensional curved surface.

7. The rotary compressive molding machine for powder material described in claim 1 and characterized by further comprising a device for spraying powder lubricant that pressurizedly sends out the powder lubricant to the powder lubricant spray means and the powder lubricant spray means and the device for spraying powder lubricant are communicating by a supply pipe line that is free from an effect of electrostatic.

8. The rotary compressive molding machine for powder material described in claim 7 and characterized by that the supply pipe line comprises an inner pipe made of insulating material inside of which the powder lubricant passes and an outer pipe made of electrically conductive material that covers the inner pipe and the outer pipe is connected to ground electrically.

9. The rotary compressive molding machine for powder material described in claim 1 and characterized by that an insulating layer is formed on the rotary table.

10. The rotary compressive molding machine for powder material described in claim 1 and characterized by that an insulating layer is formed on the upper face of the die except for vicinity of the die hole.

11. The rotary compressive molding machine for powder material described in claim 1 and characterized by comprising a nozzle that supplies an air current for electricity removal on the upper face of the rotary table to remove electricity from the powder lubricant remaining on the upper face of the die and an intake that sucks the powder lubricant from which electricity is removed.

12. The rotary compressive molding machine for powder material described in claim 2 and characterized by that the powder lubricant spraying means further comprises a powder sucking mechanism that sucks the powder lubricant that is prevented from moving upward by the air current supply mechanism.

13. The rotary compressive molding machine for powder material described in claim 2 and characterized by that the powder lubricant spray means further comprises a box body that surrounds a position where the powder lubricant is supplied, the concave face of the spray nozzle is arranged in the box body and superfluous powder lubricant scattering out of the box body is sucked by the powder sucking mechanism after passing inside the box body through an air current due to the air current supply mechanism.

14. The rotary compressive molding machine for powder material described in claim 2 and characterized by that the concave face of the spray nozzle is formed in a three-dimensional curved surface.

15. The rotary compressive molding machine for powder material described in claim 2 and characterized by further comprising a device for spraying powder lubricant that pressurizedly sends out the powder lubricant to the powder lubricant spray means and the powder lubricant spray means and the device for spraying powder lubricant are communicating by a supply pipe line that is free from an effect of electrostatic.

16. The rotary compressive molding machine for powder material described in claim 15 and characterized by that the supply pipe line comprises an inner pipe made of insulating material inside of which the powder lubricant passes and an outer pipe made of electrically conductive material that covers the inner pipe and the outer pipe is connected ground electrically.

17. The rotary compressive molding machine for powder material described in claim 2 and characterized by that an insulating layer is formed on the rotary table.

18. The rotary compressive molding machine for powder material described in claim 2 and characterized by that an insulating layer is formed on the upper face of the die except for vicinity of the die hole.

19. The rotary compressive molding machine for powder material described in claim 2 and characterized by comprising a nozzle that supplies an air current for electricity removal on the upper face of the rotary table to remove electricity from the powder lubricant remaining on the upper face of the die and an intake that sucks the powder lubricant from which electricity is removed.
